(19) United States
(12) Patent Application Publication
(10) Pub. No.: US 2024/0361162 A1
(43) Pub. Date: Oct. 31, 2024

(54) FLOW RESISTANCE TUBE FOR A FLOW SENSOR, FLOW SENSOR AND PROCESS FOR MANUFACTURING A FLOW RESISTANCE TUBE

(71) Applicant: Drägerwerk AG & Co. KGaA, Lübeck (DE)

(72) Inventors: Tobias OTTE, Lübeck (DE); Helena KASZÁS, Lübeck (DE); Ralph-Peter JACOBI, Lübeck (DE); Janto KONIK, Lübeck (DE)

(21) Appl. No.: 18/645,523

(22) Filed: Apr. 25, 2024

(30) Foreign Application Priority Data
Apr. 28, 2023 (DE) 10 2023 111 049.7

(51) Int. Cl. G01F 1/40; G01F 15/14

(52) U.S. Cl. CPC G01F 1/40; G01F 15/14

(57) ABSTRACT

A flow resistance tube for a flow sensor is provided. The flow resistance tube has a first housing part and a second housing part and a bearing element arranged between the first housing part and the second housing part. The bearing element includes a first bearing half, a second bearing half and a diaphragm element. The diaphragm element is connected between the first bearing half and the second bearing half in a non-positive manner, in particular in a non-positive sealing manner, so that the diaphragm element can be pivoted relative to the first bearing half and the second bearing half. A corresponding flow sensor and a process for manufacturing the flow resistance tube are also provided. The first bearing half and the second bearing half are sealingly connected by a sealant.

### CROSS REFERENCE TO RELATED APPLICATIONS

This application claims the benefit of priority under 35 U.S.C. § 119 of German Application 10 2023 111 049.7, filed Apr. 28, 2023, the entire contents of which are incorporated herein by reference.

### TECHNICAL FIELD

The invention relates to a flow resistance tube for a flow sensor, a corresponding flow sensor and a process for manufacturing a flow resistance tube.

### BACKGROUND

Flow resistance tubes are used in the field of medical technology, particularly as part of flow sensors. Flow sensors are used, for example, in conjunction with ventilators (respirators) to measure the flow of gases in the direction of a patient and/or in the direction away from a patient.

The measuring principle of flow sensors is based on an openable diaphragm (aperture/

orifice) element arranged in the flow resistance tube as a flow resistor, which causes a pressure drop when flow passes through the flow resistance tube. This pressure drop can be measured via pressure measurement openings upstream and downstream of the diaphragm element, for example with a pressure sensor, and correlates with the flow rate.

A general way of constructing a flow resistance tube for a flow sensor is known from EP 0 331 773 A1 and EP 3 710 788 A1.

Further flow resistance tubes are known from CN 2 02 403 742 U and CN 2 15 674 115 U.

It is essential for the functioning of the flow resistance tube or the corresponding flow sensor that the diaphragm element has a reproducible opening behavior, as this determines the measuring behavior and in particular the characteristic curve of the flow resistance tube. In addition to other mechanical properties, the opening behavior is particularly dependent on the mounting of the diaphragm element. The more reproducible the mounting can be, the more reproducible the opening behavior of the diaphragm element. The diaphragm element can generally be mounted either by clamping or by loose mounting between two boundary surfaces.

Flow sensors and their flow resistance tubes are exposed to contaminated gases depending on the installation situation. Known flow resistance tubes with loose mounting of the diaphragm element, as described for example in EP 3 710 788 A1, therefore do not meet the hygiene requirements for a reusable flow resistance tube, as impurities can penetrate the bearing gap present in the loose mounting and the bearing gap is difficult to clean.

### SUMMARY

It is an object of the invention to provide a flow resistance tube for a flow sensor, which is reprocessable, i.e. cleanable and reusable, while exhibiting reproducible measurement behavior. Furthermore, the invention is based on the object of providing a corresponding flow sensor and a corresponding process for manufacturing such a flow resistance tube.

These and other objects are attained by the flow resistance tube, flow sensor and process according to the invention. This disclosure presents advantageous embodiments of the invention. According to the invention, a flow resistance tube for a flow sensor is provided. The flow

resistance tube has a first housing part and a second housing part and a bearing element arranged between the first housing part and the second housing part. The bearing element comprises a first bearing half (first bearing bracket portion), a second bearing half (second bearing bracket portion) and a diaphragm element. The diaphragm element is received between the first bearing half and the second bearing half in non-positive connection (a frictional connection/force-fit connection), in particular in a non-positive sealing manner, so that the diaphragm element can be pivoted relative to the first bearing half and the second bearing half. The first bearing half and the second bearing half are sealingly connected by a sealant, particularly preferably on an outer surface in the circumferential direction.

In this respect, the invention is initially based on the realization that by providing a bearing element separate from the first housing part and the second housing part for receiving the diaphragm element, the bearing of the diaphragm element can be achieved with high accuracy. Thus, a reproducible opening behavior of the diaphragm element can be achieved, whereby only the manufacturing accuracy for the bearing element must be high, but no high demands must be placed on the manufacturing accuracy for the first housing part and the second housing part-since these do not directly support the diaphragm element according to the invention. The separation of functions according to the invention (mounting of the diaphragm element by the separate bearing element, formation of the housing of the flow resistance tube by the first housing part and the second housing part) therefore makes it possible, on the one hand, to provide the housing parts with a lower manufacturing accuracy that can be achieved easily and cost-effectively and, on the other hand, to nevertheless achieve a reproducible opening behavior by means of mounting of the diaphragm element by the precisely manufactured bearing element that can be provided with tight tolerances.

Furthermore, the invention is based on the further realization that by clamping the

diaphragm element between the first bearing half and the second bearing half, i.e. by the frictional connection (non-positive) mounting, a sealing effect in the direction of the bearing element interior (i.e. a cavity which may be formed between the first bearing half and the second bearing half) which is sufficient for use as a reprocessable or reusable flow resistance tube can be achieved without the need for additional sealants to be provided there.

Furthermore, the invention is based on the realization that the tightness of the bearing element against the penetration of impurities towards the interior of the bearing element can be further improved by providing a sealant.

According to the invention, a bearing element is understood to be an assembly comprising at least the first bearing half, the second bearing half and the diaphragm element, which is obtained by connecting the said components.

It is particularly preferable that the first bearing half and the second bearing half are connected to each other by a material bond, so that a state of stress or frictional connection provided during the manufacture of the bearing element can be “frozen” by preventing the bearing halves from resetting. In other words, the state of tension, i.e. the frictional connection, is maintained by the material connection and is therefore independent (within the framework of the rigidity of the bearing element) of any further pressing forces that could result from the installation between the first housing part and the second housing part. This measure ensures that the opening behavior of the diaphragm element is largely independent of the installation of the bearing element.

Advantageously, the first housing part and/or the second housing part and/or the first bearing half and/or the second bearing half are made of or comprise one or more sterilizable and autoclavable plastics. Examples of a suitable plastic are polyetheretherketone (PEEK), polyphenylsulfone (PPSU), polyoxymethylene (POM-C) and polypropylene (PP). All or some of the aforementioned components may additionally or alternatively be made of or comprise a metal such as an AISI 304 grade stainless steel. A combined embodiment may provide for a core of the housing parts and/or the bearing halves to be made of a metal, the core or cores thus obtained being overmolded (encapsulated) by a plastic in a subsequent manufacturing step.

According to the invention, a diaphragm element is understood to be an at least partially openable element arranged by means of bearing halves in the flow resistance tube as a flow resistance, which causes a pressure drop when flowing through the flow channel. For this purpose, the diaphragm element can have a hinge section and an orifice section that can be pivoted around it by elastic deformation (in other words, a “flap”). In this way, it is possible to achieve that a passage opening that can be released by pivoting becomes larger as the flow rate increases and thus a linearization of a differential pressure-flow characteristic curve (hereinafter also referred to simply as a characteristic curve) can be achieved.

The diaphragm element is advantageously configured as an essentially flat element, for example as a metal or plastic foil, into which a slot of predetermined shape is made in order to divide the diaphragm element into an outer retaining section, the hinge section and the diaphragm section, as shown, for example, in EP 0 331 773 A1. However, the exact shape of the slot is not limited to the shape shown in EP 0 331 773 A1 and can be configured differently.

A sealant is understood to be a means of sealing. A sealant can be a sealing element or a material bonding connection. An example of a sealing element is a sealing ring, a flat gasket, a profiled gasket and the like. An example of a material bonding connection is welding, such as laser welding, or gluing.

Furthermore, according to the invention, no sealing element is arranged between the diaphragm element and each of the first bearing half and the second bearing half.

In the context of the invention, it was recognized that an arrangement of a sealing element between the diaphragm element and one or both of the first bearing half and the second bearing half leads to a deterioration in the measuring behavior, as the opening behavior of the diaphragm element would be distorted too much. By dispensing with sealing elements at both interfaces, the measuring behavior of the flow resistance tube can therefore be improved.

Preferably, the first bearing half completely encloses the diaphragm element in a diaphragm element plane, and the second bearing half completely encloses the diaphragm element in the diaphragm element plane.

The diaphragm element plane is understood to be the main extension plane of the diaphragm element.

By completely enclosing the diaphragm element, it is possible to accommodate the largest possible area of the diaphragm element between the bearing halves in a non-positive (frictional connection) manner, which can advantageously reduce the surface pressure acting on the diaphragm element.

In the preferred case that the diaphragm element has the joint section, the diaphragm section (flap section) and the outer retaining section, it is also preferred that the contact surface formed between the first bearing half and the second bearing half completely accommodates the outer retaining section.

In this context, it is particularly preferable for the outer retaining section to form a circularly delimited surface, as in this way the surface available for clamping between the first bearing half and the second bearing half can be advantageously increased.

Preferably, the first bearing half and the first housing part are sealingly connected by a

first sealing element. Additionally or alternatively, it is preferred that the second bearing half and the second housing part are sealingly connected by a second sealing element.

In this way, any cavities between the bearing element, the first housing part and the second housing part can be sealed against the ingress of impurities on the flow channel side, which further improves the reprocessability or reusability of the flow resistance tube.

The first sealing element and/or the second sealing element can be formed separately from the respective housing part and/or the bearing element or alternatively be formed integrally with the respective housing part or the bearing element. Examples of separate sealing elements include sealing rings, flat gaskets or profiled gaskets. An integral (one piece) configuration is possible, for example, using a 2-component injection molding process.

In an alternative to the provision of the first sealing element and/or the second sealing element, the first bearing half and the first housing part and the second bearing half and the second housing part are sealingly connected in that the respective bearing half itself acts as a sealant through sufficiently high surface pressure against the respective housing part and through suitable material selection.

Preferably, the first housing part and the second housing part are sealingly connected to each other in an external area, i.e. in an area facing away from the flow channel, for example by a further sealant such as a sealing element or by a materially bonded seal, which can be achieved by a materially bonded connection such as laser welding.

Preferably, the first sealing element is configured as part of a first support structure, with the first support structure being inserted into a corresponding receptacle of the first housing part. Additionally, or alternatively, it is preferred that the second sealing element is formed as part of a second support structure, with the second support structure being inserted into a corresponding receptacle of the second housing part.

In this way, simple assembly of the first sealing element and/or the second sealing element is possible, since handling of the respective sealing element is simplified by providing the respective support structure. Furthermore, the targeted insertion of the respective support structure into the respective receptacle makes it possible to ensure the desired local position of the respective sealing element in the respective housing part and to prevent slippage both during assembly and during operation or reprocessing of the flow resistance tube, so that the sealing effect is advantageously improved or ensured compared to a loose insertion of a sealing element into a housing part.

Furthermore, it can be ensured in this way that the first and/or second sealing element cannot pass through the flow resistance tube towards a patient in the undesirable event that it becomes loose, as it is held in place by the support structure. In this context, it is particularly advantageous if the support structure is configured in such a way that it is larger than the cross-section of the flow resistance tube. Additionally, or alternatively, a catching device such as a grid or cross, for example made of metal, can be provided in the flow resistance tube upstream and downstream of the bearing element.

Preferably, the first sealing element and the second sealing element and, if present, the first support structure and the second support structure are identical.

Due to the reduction in the variety of parts achieved in this way, the manufacturing costs of the flow resistance tube can be advantageously reduced.

Preferably, the bearing element, particularly preferably the first bearing half or second bearing half, has a coupling element which can be connected, preferably positively (form-fitting), to a corresponding coupling receptacle of the first housing part or the second housing part, the coupling element preferably not being connectable to the corresponding other second housing part or first housing part.

In this way, the bearing element can be held securely in the corresponding housing part by means of the coupling element during assembly, which can prevent the bearing element and preferably also the corresponding sealing element, if present, from slipping during assembly.

It is preferable that a plurality of coupling elements and corresponding coupling receptacles are provided, for example four coupling elements and four coupling receptacles, in order to further improve this advantageous effect.

In the preferred, optional case that the coupling element is preferably not connectable to the corresponding other second housing part or first housing part, it can be ensured that mounting of the bearing element is only possible in a clear orientation. In particular in the event that the diaphragm element can only be pivoted uni-directionally, the functionality of the flow resistance tube can be ensured.

Preferably, the first bearing half or the second bearing half has two receiving elements for receiving the diaphragm element, whereby an orientation of the diaphragm element relative to the corresponding first bearing half or second bearing half is determined by the receiving elements.

In this way, it can be ensured that the diaphragm element is arranged in a predetermined orientation within the flow resistance tube. This improves the production of the flow resistance tube.

It is preferred that the diaphragm element is held by the receiving elements without corresponding stresses within the plane of the diaphragm element. For this purpose, the receiving elements can be configured as cylindrical or frustoconical projections, for example, and the diaphragm element can comprise corresponding circular or (possibly open) slot-like recesses, which can be brought into engagement with the projections to receive the diaphragm element. Suitable dimensioning of this pair of components can ensure that no tensile or compressive stresses are introduced within the plane of the diaphragm element. For example, a small amount of play can be provided between the receiving elements and the recesses.

According to the invention, a flow sensor comprising a flow resistance tube as described above is also provided.

The flow resistance tube can each have a pressure measurement opening upstream and downstream of the diaphragm element, which can be in fluidic connection with the flow channel on the one hand and with a differential pressure sensor on the other. The differential pressure sensor can be detachably connected to the pressure measurement openings. The flow sensor can also include a control and evaluation unit such as a microprocessor or an interface for connection to a control and evaluation unit. The control and evaluation unit can be configured to perform an analog-to-digital conversion of the differential pressure measured by the flow sensor and provided as a signal and to compare the differential pressure digitized in this way with a look-up table stored in a memory unit of the flow sensor or a connected medical device in order to determine a measured flow value and provide this via a data interface.

Preferably, the diaphragm element and the flow geometry of the flow channel are configured in such a way that the flow resistance tube or the flow sensor has a linear characteristic curve.

Preferably, any cavity between the first housing part and the second housing part is at least partially, preferably completely, filled with a suitable agent. A suitable agent is, for example, a sealing compound. This can advantageously reduce the volume of existing cavities.

According to the invention, there is also provided a process of manufacturing a flow resistance tube as described above. The process comprises the steps of: providing the first bearing half and the second bearing half, arranging the diaphragm element within the first bearing half, pressing the first bearing half and the second bearing half to frictionally receive the diaphragm element, providing the first housing part and the second housing part, connecting the first housing part, the second housing part and the bearing element to obtain the flow resistance tube.

In this way, the flow resistance tube can be advantageously maintained.

It is particularly preferred that the first bearing half and the second bearing half are joined while the first bearing half and the second bearing half are being pressed in order to obtain the bearing element. In this way, the stress state generated during pressing can be maintained by the bearing element. This can be done, for example, by material bonding the first bearing half and the second bearing half during the pressing process, for example by laser welding.

Particularly preferably, pressing is not carried out by connecting the first housing part and the second housing part and applying a corresponding force to the bearing element, although this is basically included, but by providing a pressing force by means of a pressing device. The pressing device is preferably force-controlled or force-controlled with regard to the applied pressing force, in contrast to displacement-controlled pressing, so that the stress state generated during pressing can be achieved in a particularly reproducible manner, particularly taking component tolerances into account.

The process can also comprise further steps, in particular the following: sealing of the first bearing half and the second bearing half, preferably on a surface located externally in the circumferential direction, by the sealing means and/or sealing connection of the first bearing half and the first housing part by the first sealing element and/or sealing connection of the second bearing half and the second housing part by a second sealing element and/or positive connection of the coupling element to the corresponding coupling receptacle of the first or second housing part.

In the event that the first bearing half or the second bearing half has two receiving elements for receiving the diaphragm element, the process can also have the step: receiving the diaphragm element by the receiving elements.

In the event that the first sealing element and/or the second sealing element are provided, the process may further comprise the following step(s): inserting the first support structure into a corresponding receptacle of the first housing part and/or inserting the second support structure into a corresponding receptacle of the second housing part.

These and other features and advantages of the invention are also apparent from the following description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a broken away front sectional view of an embodiment of a flow resistance tube according to the invention;

FIG. 2 is a broken away front sectional view an embodiment of a further flow resistance tube according to the invention;

FIG. 3a is a side view of an embodiment of a first housing part according to the invention;

FIG. 3b is a side view of an embodiment of a second housing part according to the invention;

FIG. 4 is a side view of an embodiment of a support structure according to the invention;

FIG. 5 is a side view of an embodiment of a diaphragm element according to the invention;

FIG. 6 is a side view of an embodiment of a first bearing half or second bearing half according to the invention;

FIG. 7 is a front sectional view of an embodiment of a bearing element according to the invention;

FIG. 8 is a flow chart showing an embodiment of a process according to the invention; and

FIG. 9 is a front view of another embodiment of a diaphragm element according to the invention.

### DESCRIPTION OF PREFERRED EMBODIMENTS

Referring to the drawings, according to the invention, a flow resistance tube 100 for a flow sensor is provided.

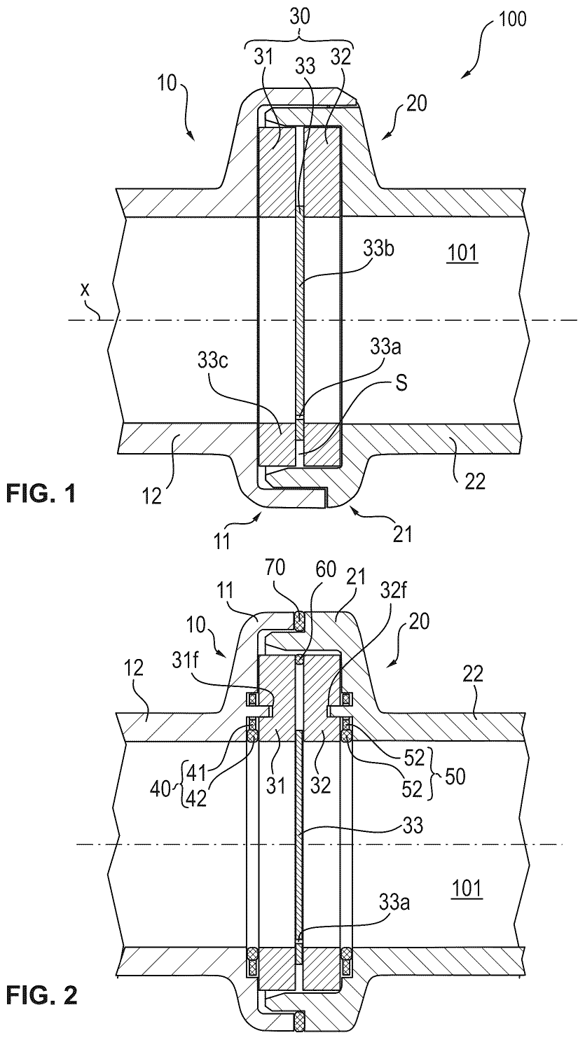

FIGS. 1 and 2 show two embodiments of a flow resistance tube 100 according to the invention in broken-off sectional views from the front.

Identical reference signs in the figures denote identical elements or different embodiments of elements.

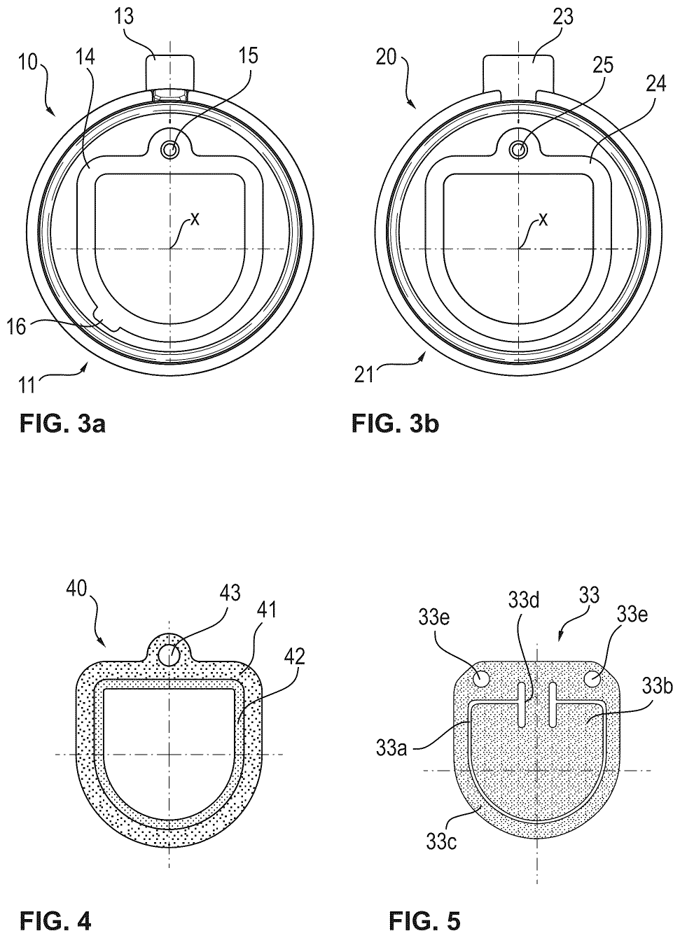

The flow resistance tube 100 has a first housing part 10 and a second housing part 20. The first housing part 10 and the second housing part 20 used in FIG. 2 are shown in FIG. 3a and FIG. 3b respectively as a side view.

As can be seen in FIGS. 1 and 2, the first housing part 10 can comprise a first housing wall 12, which can provide a first flange section 11 for connection to the second housing part 20.

As can be seen in FIGS. 1 and 2, the second housing part 20 can comprise a second housing wall 22, which can provide a second flange section 21 for connection to the first housing part 10. The first flange section 11 and the second flange section 21 can thus have a corresponding design.

The first housing part 10 and the second housing part 20 according to FIG. 2 differ from the first housing part 10 and the second housing part 20 according to FIG. 1 only in the receptacle features 14, 15, 24, 25, which are still to be described.

It cannot be seen in FIGS. 1 and 2 but can be seen in FIGS. 3a and 3b that the first housing part 10 can comprise a first pressure measurement opening 13 and the second housing part 20 a second pressure measurement opening 23, by means of which a flow channel 101 formed by the flow resistance tube 100 along the flow channel axis X can be brought into fluidic connection with a pressure measurement sensor. In the examples shown, the flow channel axis X is straight, but other shapes are also possible. Likewise, a cross-section of the flow channel 101 can be non-cylindrical, in contrast to the examples shown.

As also shown in FIGS. 1 and 2 in two different embodiments and shown as a further embodiment in FIG. 7, the flow resistance tube 100 further comprises a bearing element 30 arranged between the first housing part 10 and the second housing part 20.

In all embodiments, the bearing element 30 according to the invention comprises a first bearing half 31, a second bearing half 32 and a diaphragm element 33, wherein the diaphragm element 33 is non-positively connected between the first bearing half 31 and the second bearing half 32, so that the diaphragm element 33 is pivotable relative to the first bearing half 31 and the second bearing half 32.

As can be seen in the figures, it is preferred that the first bearing half 31 completely encloses the diaphragm element 33 in a diaphragm element plane and that the second bearing half 32 completely encloses the diaphragm element 33 in the diaphragm element plane.

An embodiment example of a diaphragm element 33, which can be provided in all embodiments of the bearing element 30, is shown in FIG. 5. The diaphragm element 33 according to FIG. 5 has a slot 33a made in it, which functionally divides the diaphragm element 33 into a diaphragm section (flap section) 33b pivotable about hinge section 33d and an outer retaining section 33c supporting the hinge section 33d. The diaphragm element 33 can also have receiving openings 33e.

The shape of the outer retaining section 33c is essentially arbitrary. In a further embodiment example of a diaphragm element 33, which can be provided in all embodiments of the bearing element 30, is shown in FIG. 9. The diaphragm element 33 according to FIG. 9 differs from that according to FIG. 5 only in that the outer retaining section 33c forms a circularly bounded surface.

In all embodiments, the diaphragm element 33 is non-positively connected (frictionally held) between the first bearing half 31 and the second bearing half 32. For example, the outer retaining section 33c can be non-positively connected by the first bearing half 31 and the second bearing half 32, so that the diaphragm section 33b is elastically pivotable about the hinge section 33d.

The outer edge of the slot 33a in relation to the diaphragm element 33 and an inner wall of the flow channel 101 can be partially flush.

In the embodiment shown in FIG. 1, the diaphragm element 33 is frictionally engaged between the first bearing half 31 and the second bearing half 32, in that the first housing part 10 and the second housing part 20 are braced relative to each other and thus provide the frictional connection via the first bearing half 31 and the second bearing half 32. For this purpose, the first housing part 10 and the second housing part 20 can be connected with variable spacing, for example by means of screws or a threaded pairing. The desired level of the clamping force, i.e. the force defining the non-positive connection, can thus be set by changing the distance between the first housing part 10 and the second housing part 20.

In the embodiment according to FIG. 2 and in the embodiment according to FIG. 3, the diaphragm element 33 between the first bearing half 31 and the second bearing half 32 is achieved in a non-positive connection due to suitable tensioning of the first bearing half 31 and the second bearing half 32 relative to one another. For this purpose, the first bearing half 31 and the second bearing half 32 with the diaphragm element 33 arranged between them are braced against each other during the manufacture of the bearing element 30 and the state of tension thus achieved is fixed by connecting the two bearing halves 31, 32, for example by material bonding.

By connecting the first housing part 10, the second housing part 20 and the bearing element 30, a continuous flow channel 101 can thus be provided, in which the diaphragm element 33 is pivotably arranged.

According to the invention and as can be seen in FIGS. 1, 2 and 7, no sealing element is arranged between the diaphragm element 33 and each of the first bearing half 31 and the second bearing half 32.

In accordance with the invention and thus in all embodiments, and shown in FIG. 2, the first bearing half 31 and the second bearing half 32 are sealingly connected by a sealant (sealing means) 60. In this respect, a sealing element such as a sealing ring or a seal by means of a material bonding connection, for example by laser welding, can be considered as sealant 60. A sealing connection of the first bearing half 31 and the second bearing half 32 by the sealant 60 is realized in the embodiment according to FIG. 7, for example, in that the circumferential gap located on the outside in relation to the bearing element 30 can be closed by the sealant 60.

It is preferable and possible in all embodiments, and specifically shown in the embodiment according to FIG. 2, that the first bearing half 31 and the first housing part 10 can be sealingly connected by a first sealing element 40, 42, and/or the second bearing half 32 and the second housing part 20 can be sealingly connected by a second sealing element 50, 52. The respective sealing element 40, 50 can, for example, be a seal 42, 52.

It is also preferable and possible in all embodiments, and specifically shown in the embodiment according to FIG. 2, that the first sealing element 40, 42 is configured as part of a first support structure 41, wherein the first support structure 41 is inserted into a corresponding receptacle 14, 15 of the first housing part 10 and/or wherein the second sealing element 50, 52 is configured as part of a second support structure 51, wherein the second support structure 51 is inserted into a corresponding receptacle 24, 25 of the second housing part 20.

An embodiment of a first sealing element 40 for use in all embodiments is shown by way of example in FIG. 4. The sealing element 40 shown there has a first support structure 41 which-preferably non-detachably-accommodates a seal 42. The first sealing element 40 or the first support structure 41 can also have a support receptacle 43. The second sealing element 50 can be configured identically to the first sealing element 40, so that the second sealing element 50 is not shown separately.

An embodiment of a corresponding receptacle 14, 15 of the first housing part 10 is shown in FIG. 3a and an embodiment of a corresponding receptacle 24, 25 of the second housing part 20 is shown in FIG. 3b. In this respect, the first housing part 10 can have a first receiving groove 14 for receiving the first sealing element 40, the shape of which can essentially correspond to that of the first support structure 41. The first housing part 10 can furthermore have a first receiving pin 15, i.e. a projection, which can be brought into engagement with the support receptacle 43. Thus, the first sealing element 40 can be advantageously received in the first housing part 10. The second housing part 20 can have, corresponding to the first housing part 10, a second receiving groove 24 for receiving the second sealing element 50, the shape of which can essentially correspond to that of the second support structure 51. The second housing part 20 can furthermore have a second receiving pin 25, which can be brought into engagement with a support receptacle 53 of the second support structure 51. Thus, the second sealing element 50 can be received in the second housing part 20 in an advantageous and comparable manner.

It is preferable and possible in all embodiments and specifically shown in FIGS. 3a and 7 that the bearing element 30 has a coupling element 31e, which can be connected to a corresponding coupling element in the form of a coupling receptacle 16 of the first housing part 10 or the second housing part 20, wherein the coupling element 16 cannot be connected to the corresponding other second housing part 20 or first housing part 10. The coupling element 31e can, for example, be a protrusion or a recess, whereby it is configured as a protrusion in the example according to FIG. 7. The coupling receptacle 16 is configured to correspond to the coupling element and can, for example, be a recess or a protrusion, whereby it is configured as a recess in the example according to FIG. 3a. As can be seen in the comparison between FIGS. 3a and 3b, in the exemplary embodiment only the first housing part 10 has the coupling receptacle 16, but not the second housing part 20, so that the coupling element 31e can only be connected to the first housing part 10.

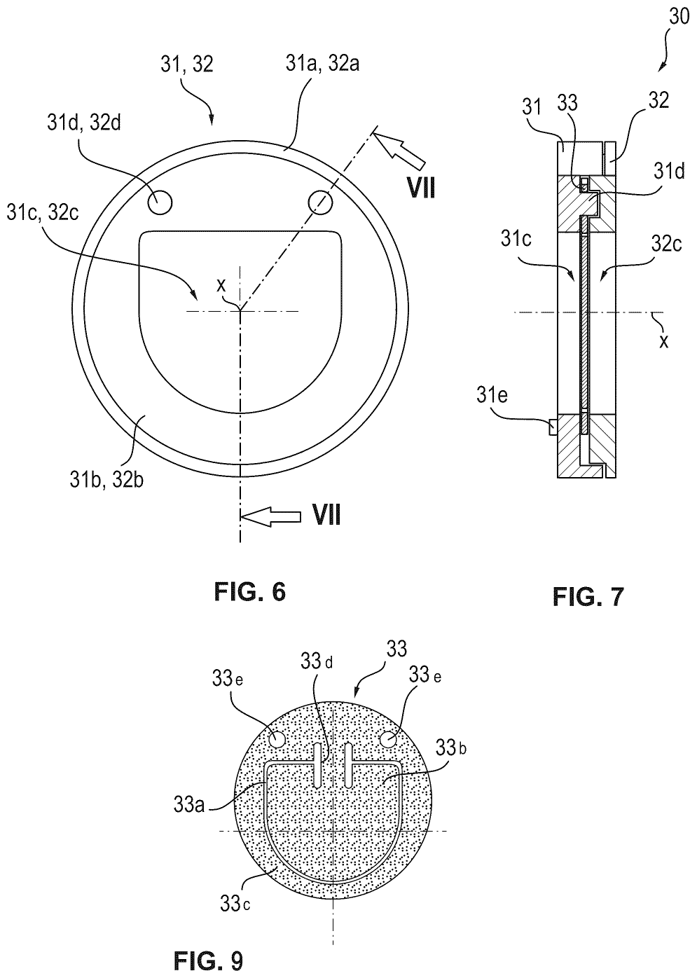

It is preferable and possible in all embodiments and specifically shown in FIGS. 6 and 7 that the bearing halves 31, 32 comprise a first or second bearing base 31b, 32b, which defines a base surface of the respective bearing half 31, 32, a respective first or second bearing wall 31a, 32a, which extends away from the respective bearing base 31b, 32b, and a first or second bearing opening 31c, 32c, which extends through the respective bearing element 31, 32. The respective bearing base 31b, 32b forms a bearing surface on its inner side in relation to the bearing element 30, which is set up to receive the diaphragm element 33 in a clamping or non-positive manner and must therefore be manufactured with sufficient accuracy as described in order to achieve a reproducible opening behavior of the diaphragm element 33.

It is also preferable and possible in all embodiments, and specifically shown in FIGS. 6 and 7, that the first bearing half 31 or the second bearing half 32 has two (or more) receiving elements 31d, 32d for receiving the diaphragm element 33, wherein an orientation of the diaphragm element 33 relative to the corresponding first bearing half 31 or second bearing half 32 is defined by the receiving elements 31d, 32d.

In the embodiment shown in FIG. 1, the first bearing half 31 has the receiving elements 31d. The corresponding other bearing element, in the case of FIG. 7 thus the second bearing element 32, can have a recess corresponding to the receiving elements 31d of the first bearing element 31 in order to be advantageously engageable with the receiving elements 31d.

Furthermore, it is preferred and possible in all embodiments, and specifically shown in FIG. 2, that one of the bearing halves 31, 32 or both bearing halves 31, 32 can have a first bearing receptacle (holder/seat) 31f or a second bearing receptacle (holder/seat) 32f in order to be connectable to the receptacle 15 of the first housing part 10 or to the first receptacle pin 15 or to the receptacle 25 of the second housing part 20 or to the second receptacle pin 25.

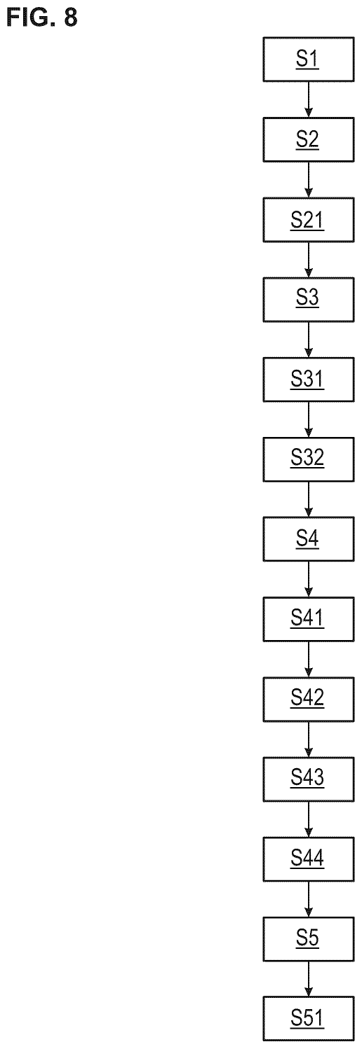

FIG. 8 shows an embodiment of a process 200 according to the invention for manufacturing a flow resistance tube 100 as described above.

The process 200 comprises at least the steps of: S1 providing the first bearing half 31 and the second bearing half 32, S2 arranging the diaphragm element 33 within the first bearing half 31, S3 pressing the first bearing half 31 and the second bearing half 32 to non-positively connect the diaphragm element 33, S4 providing the first housing part 10 and the second housing part 20, connecting the first housing part 10, the second housing part 20 and the bearing element 30 to obtain the flow resistance tube 100.

It is preferred and shown in FIG. 8 that the process 200 may optionally comprise the following step: S31 providing a sealing connection of the first bearing half 31 and the second bearing half 32 using a sealant 60. Step S31 can be carried out, for example, by connecting the first bearing half 31 and the second bearing half 32 in a material bonding connection during the pressing in step S3 and thus sealing them, for example by laser welding.

It is further preferred and shown in FIG. 8 that the process 200 may optionally comprise one or more of the following steps: S32 joining the first bearing half 31 and the second bearing half 32; and/or S41 sealingly connecting the first bearing half 31 and the first housing part 10 by means of the first sealing element 40, 42; and/or S42 sealingly connecting the second bearing half 32 and the second housing part 20 by means of the second sealing element 50, 52; and/or S51 positively connecting the coupling element 31 to the corresponding coupling receptacle 16 of the first housing part 10 or the second housing part 20.

If the sealant 60 is a material bonding connection, step S31 and step S32 are identical.

For the case shown in FIGS. 6 and 7 and possible in all embodiments in which the first bearing half 31 or the second bearing half 32 has two receiving elements 31d, 32d for receiving the diaphragm element 33, the process 200 may further comprise the step: S21 receiving the diaphragm element 33 by the receiving elements 31d, 32d.

For the case shown in FIG. 2 and possible in all embodiments in which the first sealing element 40, 42 and/or the second sealing element 50, 52 are provided, the process 200 may further comprise the following step(s): S43 inserting the first support structure 40 into a corresponding receptacle 14, 15 of the first housing part 10; and/or S44 inserting the second support structure 50 into a corresponding receptacle 24, 25 of the second housing part 20.

All of the features described herein can be combined with one another, provided that this does not affect alternatives or is not contradictory.

While specific embodiments of the invention have been shown and described in detail to illustrate the application of the principles of the invention, it will be understood that the invention may be embodied otherwise without departing from such principles.

### LIST OF REFERENCE CHARACTERS

10 First housing part
11 First flange section
12 First housing wall
13 First pressure measurement opening
14 Receptacle, first receiving groove
15 Receptacle, first receiving pin
16 Coupling receptacle
20 Second housing part
21 Second flange section
22 Second housing wall
23 Second pressure measurement opening
24 Receptacle, second receiving groove
25 Receptacle, second receiving pin
30 Bearing element
31 First bearing half (first bearing bracket portion)
31a First bearing wall
31b First bearing base
31c First bearing opening
31d Receiving element
31e Coupling element
31f First bearing receptacle (holder/seat)
32 Second bearing half (second bearing bracket portion)
32a Second bearing wall
32b Second storage base
32c Second bearing opening
32d Receiving element
32f Second bearing receptacle (holder/seat)
33 Diaphragm element
33a Slot
33b Diaphragm section
33c Outer retaining section
33d Joint section
33c Receiving opening
40 First scaling element
41 First support structure
42 Seal
43 Support mount
50 Second sealing element
51 Second support structure
52 Seal
60 Sealant
70 Further sealant
100 Flow resistance tube
101 Flow channel
200 Process
S1, S2, . . . Process steps
S Slit (gap)
X Flow channel axis

What is claimed is:

1. A flow resistance tube for a flow sensor, the flow resistance tube comprising:
a first housing part;
a second housing part;
a bearing element arranged between the first housing part and the second housing part, the bearing element comprising:
a first bearing half;
a second bearing half; and
a diaphragm element; and
a sealant sealingly connecting the first bearing half and the second bearing half,
wherein the diaphragm element is non-positively connected between the first bearing half and the second bearing half such that the diaphragm element is pivotable relative to the first bearing half and the second bearing half, and
wherein no sealing element is arranged between the diaphragm element and the first bearing half and no sealing element is arranged between the diaphragm element and the second bearing half.

2. A flow resistance tube according to claim 1,
wherein the first bearing half completely encloses the diaphragm element in a diaphragm element plane, and
wherein the second bearing half completely encloses the diaphragm element in the diaphragm element plane.

3. A flow resistance tube according to claim 1, further comprising a first sealing element and/or a second sealing element,
wherein the first bearing half and the first housing part are sealingly connected by the first sealing element, and/or
wherein the second bearing half and the second housing part are sealingly connected by the second sealing element.

4. A flow resistance tube according to claim 3,
wherein the first sealing element is formed as part of a first support structure that is inserted into a corresponding receptacle of the first housing part, and/or
wherein the second sealing element is formed as part of a second support structure that is inserted into a corresponding receptacle of the second housing part.

5. A flow resistance tube according to claim 4, wherein the first sealing element and the first support structure are formed identically to the second sealing element and the second support structure.

6. A flow resistance tube according to claim 3, wherein the first sealing element and the second sealing element are identically formed.

7. A flow resistance tube according to claim 1,
wherein the first housing part or the second housing part comprises a coupling element comprising a coupling receptacle, and
wherein the bearing element further comprises a coupling element configured to be connected to the coupling receptacle of the first housing part or of the second housing part and the coupling receptacle of the first housing part or of the second housing part corresponds to the coupling element of the bearing element.

8. A flow resistance tube according to claim 7, wherein the coupling element of the first housing part or of the second housing is configured to not be connectable to the other of the first housing part or the second housing part.

9. A flow resistance tube according to claim 1,
wherein the first bearing half or the second bearing half has two receiving elements for receiving the diaphragm element, and
wherein an orientation of the diaphragm element relative to the corresponding first bearing half or second bearing half is fixed by the receiving elements.

10. A flow sensor comprising a flow resistance tube, the flow resistance tube comprising:
a first housing part;
a second housing part;
a bearing element arranged between the first housing part and the second housing part, the bearing element comprising:
a first bearing half;
a second bearing half; and
a diaphragm element; and
a sealant sealingly connecting the first bearing half and the second bearing half,
wherein the diaphragm element is non-positively connected between the first bearing half and the second bearing half such that the diaphragm element is pivotable relative to the first bearing half and the second bearing half, and
wherein no sealing element is arranged between the diaphragm element and the first bearing half and no sealing element is arranged between the diaphragm element and the second bearing half.

11. A flow sensor according to claim 10,
wherein the first bearing half completely encloses the diaphragm element in an diaphragm element plane, and
wherein the second bearing half completely encloses the diaphragm element in the diaphragm element plane.

12. A flow sensor according to claim 10,
wherein the flow resistance tube further comprises a first sealing element and/or a second sealing element,
wherein the first bearing half and the first housing part are sealingly connected by the first sealing element, and/or the second bearing half and the second housing part are sealingly connected by the second sealing element.

13. A flow sensor according to claim 12,
wherein the first sealing element is formed as part of a first support structure that is inserted into a corresponding receptacle of the first housing part, and/or
wherein the second sealing element is formed as part of a second support structure that is inserted into a corresponding receptacle of the second housing part.

14. A flow sensor according to claim 13, wherein the first sealing element and the first support structure are formed identically to the second sealing element and the second support structure.

15. A flow sensor according to claim 12, wherein the first sealing element and the second sealing element are identically formed.

16. A flow sensor according to claim 10,
wherein the first housing part or of the second housing comprises a coupling element comprising a coupling receptacle, and
wherein the bearing element further comprises a coupling element configured to be connected to the coupling receptacle of the first housing part or of the second housing part and the coupling receptacle of the first housing part or of the second housing part corresponds to the coupling element of the bearing element.

17. A flow sensor according to claim 16, wherein the coupling element of the first housing part or of the second housing is configured to not be connectable to the other of the first housing part or second housing part.

18. A flow sensor according to claim 10,
wherein the first bearing half or the second bearing half has two receiving elements for receiving the diaphragm element, and
wherein an orientation of the diaphragm element relative to the corresponding first bearing half or second bearing half is fixed by the receiving elements.

19. A process of manufacturing a flow resistance tube comprising: a first housing part; a second housing part; a bearing element arranged between the first housing part and the second housing part, the bearing element comprising: a first bearing half; a second bearing half; and a diaphragm element; and a sealant sealingly connecting the first bearing half and the second bearing half, wherein the diaphragm element is non-positively connected between the first bearing half and the second bearing half such that the diaphragm element is pivotable relative to the first bearing half and the second bearing half, and wherein no sealing element is arranged between the diaphragm element and the first bearing half and no sealing element is arranged between the diaphragm element and the second bearing half, the process comprising the steps of:
providing the first bearing half and the second bearing half;
arranging the diaphragm element within the first bearing half;
pressing the first bearing half and the second bearing half to non-positively connect the diaphragm element;
providing a sealing connection of the first bearing half and the second bearing half using the sealant;
providing the first housing part and the second housing part; and
connecting the first housing part, the second housing part and the bearing element to obtain the flow resistance tube.

20. A process according to claim 19, further comprising:
providing a first sealing element and/or a second sealing element; and
scalingly connecting the first bearing half and the first housing by the first sealing element, and/or scalingly connecting the second bearing half and the second housing part by the second sealing element.
